(19) United States
(12) Patent Application Publication
(10) Pub. No.: US 2010/0275737 A1
(43) Pub. Date: Nov. 4, 2010

(54) BI-DIRECTIONAL RATCHET WRENCH

(76) Inventor: Chien-Yueh LIN, Dali City (TW)

Correspondence Address: Ching-Ling Huang, 5597 NW 127th Ter, Portland, OR, 97229, US

(21) Appl. No.: 12/433,906

(22) Filed: May 1, 2009

(51) Int. Cl. B25B 13/46

(52) U.S. Cl. 81/63

(57) ABSTRACT

A bi-directional ratchet wrench includes a handle with a head at a front side formed a housing trough to hinge a ratchet wheel which has ratchet teeth on the perimeter and a knob strut jutting from one end surface, a switch element located in a swivel space formed at the housing trough with a plurality of harness teeth formed respectively on the left and right sides of a front end to allow the harness teeth on one side to engage with the ratchet teeth, and having a rear side formed with two concave portions, and confined at a selected swivel angle on the left and right sides by two retaining troughs formed in the swivel space, a butting unit having an elastic element embedded in the head and a spherical butting member butting the concave portions, and a sealing lid to seal the ratchet wheel and switch element.

### FIELD OF THE INVENTION

The present invention relates to a bi-directional ratchet wrench that has a switch element anchored by an elastic butting unit and harness teeth on two front sides of the switch element engaged with a ratchet wheel to control unidirectional turning of the ratchet wheel so that the butting unit does not turn to prevent wearing and elastic fatigue and malfunction.

### BACKGROUND OF THE INVENTION

A conventional ratchet wrench such as the one shown in FIG. 1 mainly includes a handle 1 which has a front end expanded outwards to form a head 2. The head 2 is pivotally coupled with a ratchet wheel 3 which has a radial surface jutted with a square driving portion 4 formed thereon to couple with a bolt or nut (not shown in the drawing) for tightening or loosening use. The head 2 also has two actuation elements 5a and 5b that have one end hinged on the head 2 and the other end with harness teeth 6 formed thereon engaging with ratchet teeth formed on the perimeter of the ratchet wheel 3. The actuation elements 5a and 5b are butted respectively by a spring 7 from an outer side. There is a cam 8 located between the two actuation elements 5a and 5b. Turning the cam 8 can push one actuation element 5a on one side away so that the harness teeth 6 at the front side escape the ratchet teeth of the ratchet wheel 3, while the actuation element 5b on the other side is pushed inwards by the elastic force of another spring 7 on the outer side so that its harness teeth 6 are engaged with the ratchet teeth of the ratchet wheel 3. Thus by turning the handle 1 clockwise, the ratchet wheel 3 is braked by the actuation element 5b at one side without moving and can drive the bolt to rotate. By turning the handle 1 counterclockwise, the ratchet wheel 3 pushes the actuation element 5b outwards to compress the spring 7, then the ratchet wheel 3 turns idly without driving the bolt to rotate.

As the turning torsional force is concentrated on the harness teeth 6 at the front side of the actuation elements 5a and 5b, the harness teeth 6 are easily broken due to excessive torsional force.

To remedy the aforesaid problem, another type of ratchet wrench was developed as shown in FIGS. 2 and 3. It has a handle 1b and a round head 2b at the front side of the handle 1b. The head 2b is hinged with a ratchet wheel 3b to incorporate with an adjustment member 4b. The adjustment member 4b has teeth 4c on a left side and right side of the front edge to engage with the ratchet teeth of the ratchet wheel 3b. The adjustment member 4b further has two undulate arched surfaces 4d at the rear side. There is a control knob 5b with one end movable by a user's hand and the other end with a strut type control member 5c located thereon and hinged on the head 2b. The control member 5c has a cavity to hold an elastic element 6b which has a front side butting a steel ball 7b. The steel ball 7b is exposed to butt the arched surface 4d of the adjustment member 4b.

The adjustment member 4b can be swiveled leftwards or rightwards through the elastic force of the elastic element 6b so that the teeth 4c at the front side of the adjustment member 4b can engage with the ratchet teeth formed on the perimeter of the ratchet wheel 3b. Thereby the ratchet wheel 3b can turn only in one direction. And a torsional strut 3c at one end of the ratchet wheel 3b can be coupled with a bolt or a nut, and drive the bolt or nut in one direction for tightening or loosening.

However, in practice, the control member 5c is swayed left and right with the control knob 5b, and the steel ball 7b also receives constant friction and results in wearing off. The elastic element 6b is compressed and released frequently to push the steel ball 7b, and elastic fatigue easily occurs. As a result, the adjustment member 4b could be stuck and cause unsmooth operation.

### SUMMARY OF THE INVENTION

Therefore, the primary object of the present invention is to provide a bi-directional ratchet wrench to prevent wearing of a butting unit and sticking of a switch element that result in difficulty of changing wrenching directions, and tightening or loosening bolt.

To achieve the foregoing object, the bi-directional ratchet wrench according to the invention includes:

a handle which has a front side expanded to become a head with a housing trough formed inside and a swivel space at the rear side of the housing trough. The swivel space has a retaining trough respectively on the left side and the right side at the rear side thereof;

a ratchet wheel which is hinged on the housing trough and has a plurality of ratchet teeth formed annularly on the perimeter and a knob strut jutting from one end surface thereof;

a switch element which is held in the swivel space and swivelable to be confined by the retaining troughs at a selected swivel angle on the left side and right side, and has a plurality of harness teeth at the front end on the left side and right side to engage with the ratchet teeth, and two arched concave portions at the rear side abutting each other;

a butting unit which is axially embedded in the head and has a front end butting the concave portions of the switch element in an elastic and extendible manner; and

a sealing lid which is located at one side of the head and has a retaining opening at the front side run through by the knob strut.

By means of the construction set forth above, the switch element can be driven to sway left and right so that the harness teeth at the front side can engage with the ratchet teeth, and the concave portions of the switch element can be elastically butted by the butting unit so that the knob strut can drive a bolt or nut in one direction for tightening or loosening, but turn idly in the reverse direction.

The invention provides many advantages, notably:

The butting unit is fixedly embedded in the head without swaying. Change direction of the ratchet wheel for applying force is accomplished by swaying the switch element leftwards and rightwards to make a butting member to butt the concave portions of the switch element so that direction can be switched and latched and the butting member does not move due to swaying. Wearing and defect latching also can be prevented in direction switching.

The foregoing, as well as additional objects, features and advantages of the invention will be more readily apparent from the following detailed description, which proceeds with reference to the accompanying embodiment and drawings. The embodiment serves only for illustrative purpose, and is not the limitation of the invention.

### BRIEF DESCRIPTION OF THE DRAWINGS

FIG. 1 is a plane view of a conventional ratchet wrench.

FIG. 2 is a plane view of another conventional ratchet wrench in operating condition-1.

FIG. 3 is a plane view of another conventional ratchet wrench in operating condition-2.

FIG. 4 is a perspective view of an embodiment of the invention.

FIG. 5 is a schematic view of an embodiment of the invention in operating condition-1.

FIG. 6 is a schematic view of an embodiment of the invention in operating condition-2.

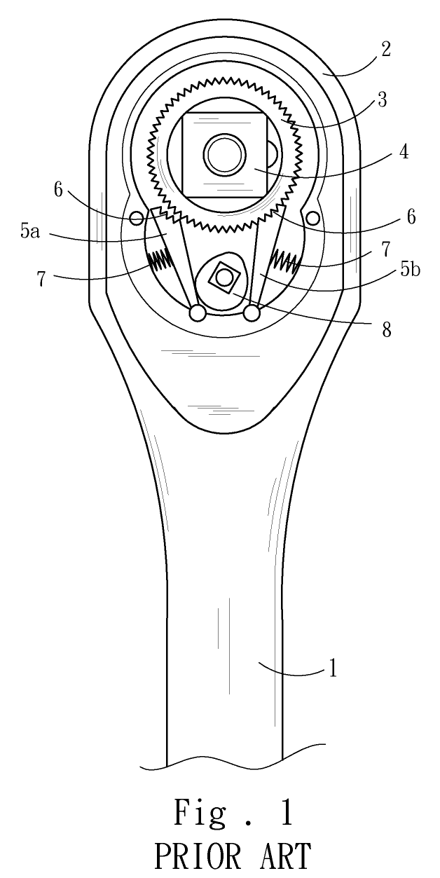

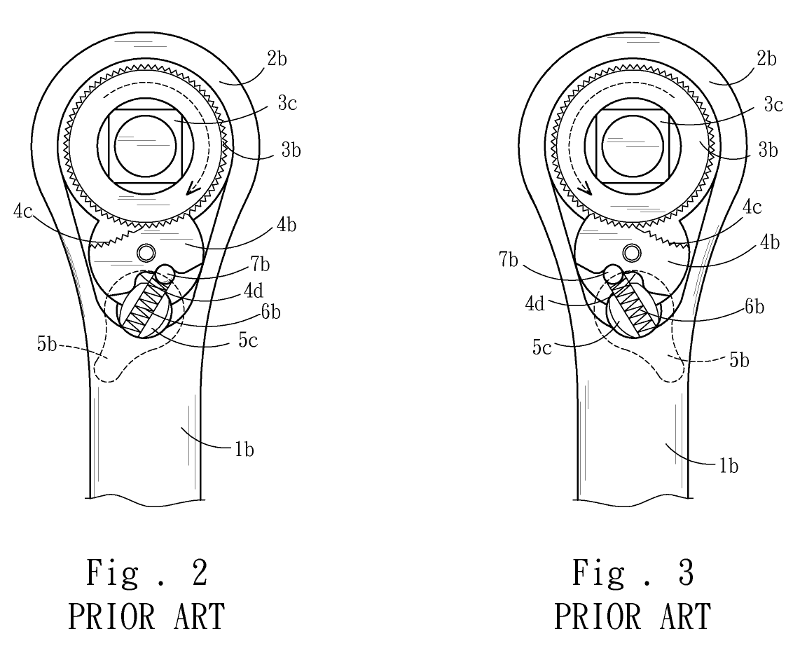

### DETAILED DESCRIPTION OF THE PREFERRED EMBODIMENT

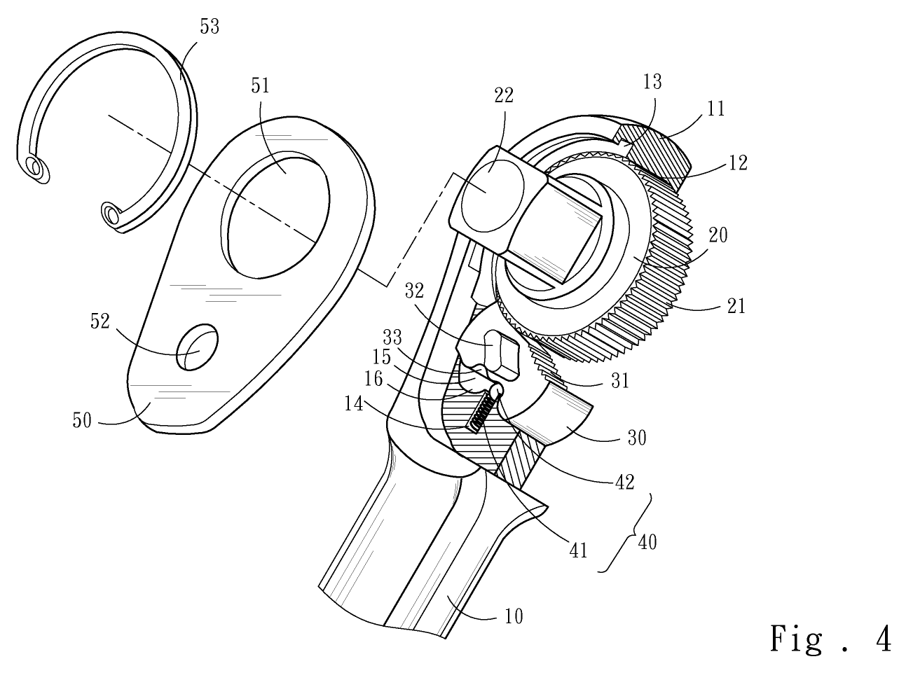

Please refer to FIGS. 4, 5 and 6 for an embodiment of the invention. The bi-directional ratchet wrench of the invention aims to tighten or loosen a bolt or nut. It includes a handle 10, a ratchet wheel 20, a switch element 30, a butting unit 40 and a sealing lid 50.

The handle 10 aims to be grasped by a user's hand for turning and has a front side expanded to become a round head 11 with a housing trough 12 formed inside. The housing trough 12 is circular at the front side and has a swivel space 15 at the rear side. The swivel space 15 has a retaining trough 16 respectively concaved on the left side and the right side directing rearwards. The housing trough 12 is surrounded annularly by a groove 13. The head 11 has an axial cavity 14 at the rear side with a front opening communicating to the swivel space 15.

The ratchet wheel 20 is hinged on the housing trough 12 and can rotate therein. It has a plurality of ratchet teeth 21 formed on the perimeter and a square knob strut 22 jutting from one end surface thereof to couple with a bolt or nut for tightening or loosening thereof.

The switch element 30 is a block-like element held in the swivel space 15, and is confined by the retaining troughs 16 at a selected swivel angle on the left side and right side, and has a plurality of harness teeth 31 on the left side and right side at the front end thereof. The switch element 30 also has a turning knob 32 jutting from one end surface and two arched concave portions 33 at the rear side abutting each other.

The butting unit 40 is axially embedded in the head 11, and has an elastic element 41 (such as a spring) extensible axially and a spherical butting member 42 (such as a steel ball) at the front side of the elastic element 41 that are held in the cavity 14. The butting member 42 is pushed by the elastic force of the elastic element 41 so that its front end is jutting outwards to butt the concave portions 33 to anchor the switch element 30.

The sealing lid 50 is a plate held in the housing trough 12, and has a retaining opening 51 at the front side and an aperture 52 at the rear side. The retaining opening 51 is run through by the knob strut 22. The turning knob 32 of the switch element 30 runs through the aperture 52 and is turnable by user's hand. A C-shaped wedging ring 53 is provided on an outer side of the sealing lid 50 and wedged in the groove 13 of the housing trough 12 to fasten the sealing lid 50 on the head 11.

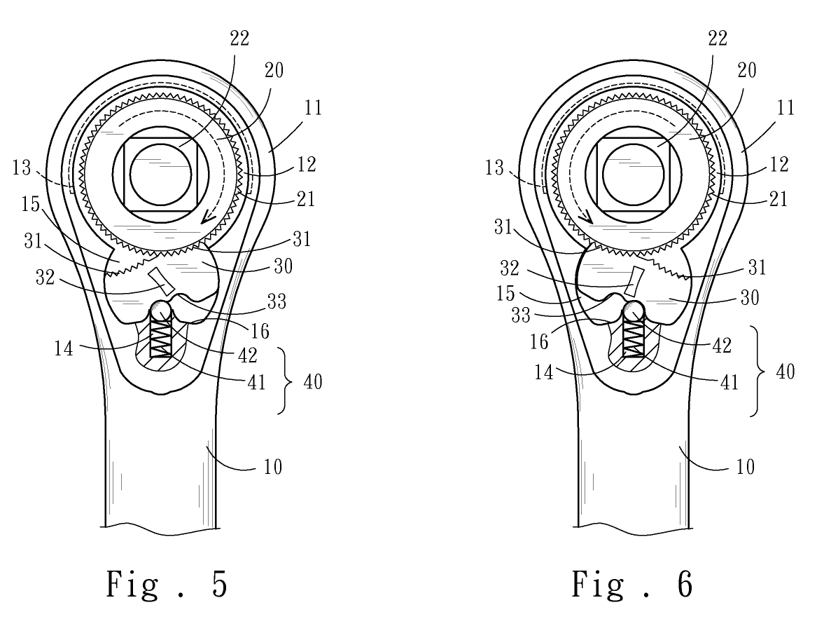

Referring to FIG. 5, when in use, the turning knob 32 of the switch element 30 is turned in a tilted manner to one side so that the harness teeth 31 on the right side of the front end are engaged with the ratchet teeth 21 on the perimeter of the ratchet wheel 20, while the concave portion 33 on the left side of the lower end is pressed by the butting member 42 and anchored. Turn the handle 10 clockwise, the ratchet wheel 20 is driven in one direction to tighten a bolt or nut. On the other hand, turning the handle 10 counterclockwise, the ratchet teeth 21 turn reverse to depress the harness teeth 31 on the right side of the switch element 30 downwards, the butting member 42 also is depressed to compress the elastic element 41 so that the ratchet wheel 20 turns idly in the reverse direction without driving the bolt or nut. Hence unidirectional driving can be accomplished.

Referring to FIG. 6, when in use for bolts or nuts of a different threading direction, the switch element 30 turns to another side so that the harness teeth 31 on the left side of the front end engage with the ratchet teeth 21 of the ratchet wheel 20. The handle 10 can be turned counterclockwise, and the switch element 30 actuates swiveling of the ratchet wheel 20 so that the knob strut 22 can drive the bolt or nut to turn. If the handle 10 is turned clockwise, the ratchet teeth 21 of the ratchet wheel 20 depress the switch element 30 to form idle turning, then unidirectional driving also can be accomplished.

The invention provides an advantage by controlling the ratchet wheel 20 to switch driving direction and anchor. By swaying the switch element 30 leftwards and rightwards, one of the concave portions 33 located below can be pushed elastically by the butting member 42 to an anchoring position. The butting member 42 is embedded in the cavity 14 without swaying leftwards or rightwards, hence the butting member 42 does not sway frequently and wearing can be reduced and loosening can be prevented. Elastic fatigue of the elastic element 41 also can be avoided, and latch defect can be eliminated.

What is claimed is:

1. A bi-directional ratchet wrench, comprising:
a handle which has a front side expanded to form a head, the head having a housing trough and a swivel space at a rear side of the housing trough, the swivel space having a retaining trough respectively on a left side and a right side at a rear side thereof;
a ratchet wheel which is hinged on the housing trough and has a plurality of ratchet teeth formed annularly on the perimeter and a knob strut jutting from one end surface thereof;
a switch element which is held in the swivel space and swivelable to be confined by the retaining troughs at a selected swivel angle on the left side and the right side, and has a plurality of harness teeth at the front end on the left side and right side thereof to engage with the ratchet teeth, and two arched concave portions at a rear side thereof abutting each other;
a butting unit which is axially embedded in the head and has a front end elastically butting the concave portions of the switch element in an extensible manner; and
a sealing lid which is located at one side of the head and has a retaining opening at a front side run through by the knob strut.

2. The bi-directional ratchet wrench of claim 1, wherein the switch element has one end surface which has a jutting turning knob formed thereon.

3. The bi-directional ratchet wrench of claim 2, wherein the sealing lid has an aperture at a rear side run through by the turning knob.

4. The bi-directional ratchet wrench of claim 1, wherein the sealing lid has a C-shaped wedging ring located outside, the housing trough having an annular groove on the periphery wedged by the C-shaped wedging ring.

5. The bi-directional ratchet wrench of claim 1, wherein the butting unit includes an elastic element extensible axially and a spherical butting member located at a front end of the elastic element.

6. The bi-directional ratchet wrench of claim 5, wherein the elastic element is a spring, the butting member being a steel ball, the head having an axial cavity at a rear side thereof, the cavity having a front opening communicating to the swivel space, the cavity holding the elastic element and the butting member which has a front end jutting to butt the concave portions.

7. The bi-directional ratchet wrench of claim 1, wherein the knob strut is square.
